(19) United States
(12) Patent Application Publication
(10) Pub. No.: US 2024/0265341 A1
(43) Pub. Date: Aug. 8, 2024

(54) SYSTEM AND METHOD FOR APPLYING DYNAMIC GEOFENCE

(71) Applicant: Door Dash, Inc., San Francisco, CA (US)

(72) Inventors: Margorita Golovonevsky, San Francisco, CA (US); Ram Tripathi, Lexington, KY (US)

(73) Assignee: Door Dash, Inc., San Francisco, CA (US)

(21) Appl. No.: 18/436,875

(22) Filed: Feb. 8, 2024

Related U.S. Application Data
(60) Provisional application No. 63/483,878, filed on Feb. 8, 2023.

(51) Int. Cl. G06Q 10/087; G06Q 10/083; G06Q 50/12

(52) U.S. Cl. CPC G06Q 10/087; G06Q 10/083; G06Q 50/12

(57) ABSTRACT

Systems and methods for minimizing transporter wait times are disclosed. A server computer associated with an item fulfillment service organization (e.g., an organization that manages the delivery of items, such as food, to end users), can estimate the amount of time it will take to prepare an item (e.g., a meal) by a service provider (e.g., a restaurant). The server computer can also estimate the amount of time it will take a transporter (e.g., a delivery driver) to travel to the service provider in order to retrieve the item. The server computer can use machine learning to perform this estimation process. Based on these time estimations, the server computer can time the release of messages to transporters and service providers, in order to minimize the amount of time that a transporter is waiting for an item to be prepared by a service provider.

### CROSS-REFERENCES TO RELATED APPLICATIONS

This application is a non-provisional application of U.S. Provisional Application No. 63/483,878, filed on Feb. 8, 2023, which is herein incorporated by reference in its entirety.

### SUMMARY

Embodiments of the present disclosure are directed to computerized systems and methods for efficiently reducing both transporter wait times and item wait times in relation to item fulfillments. Item wait times and transporter wait times are minimized when transporters arrive at service providers at roughly the same time as service providers complete preparation of items. Embodiments may be particularly useful in the case meal deliveries from “quick service restaurants.”

As a general summary, a server computer (e.g., a computer system associated with an item fulfillment service organization) can optionally determine whether a particular item fulfillment order (e.g., a meal delivery) qualifies for “automatic order release.” As background, in an automatic order release, a service provider (e.g., a restaurant) is typically informed to begin preparing an item after a transporter (e.g., a delivery driver) is informed to retrieve that item. When the transporter gets within a certain distance of the service provider (defined, for example, by a “geofence”), the server computer can inform the service provider so that the service provider can begin preparation of any items. Automatic order releases can be useful in the context of meal delivery from quick service restaurants, which sometimes prepare meals in less time than it takes for transporters to arrive at those restaurant, leading to item wait times.

After optionally determining whether the item fulfillment order qualifies for automatic order release, the server computer can generate an accurate estimate of the amount of time it will take a service provider (e.g., a restaurant) to prepare an item (e.g., a meal) for transportation. Additionally, the server computer can accurately estimate of the amount of time it will take for a transporter to travel to a service provider. In both cases, the server computer can leverage machine learning to generate this “service provider preparation time estimate” and “transporter time estimate.” For example, the server computer can train a machine learning model to predict the amount of time it takes a restaurant to complete an order based on features such as: the amount of time for similar restaurants to complete similar orders, the time of day or day of the year, how busy the restaurant is (e.g., based on the current order volume), etc.

The “transporter time estimate” can be derived from a combination (e.g., a sum) of multiple time estimates, related to different events or time periods associated with the transportation of items. As an example, a “transporter confirmation time estimate” can correspond to the expected latency between when an item fulfillment request is initially processed and made available to transporters, and when a transporter begins the process of completing that item fulfillment request. Other contributors to the transporter time estimate can include a transporter distance-based time estimate, a transporter parking and pickup time estimate, and in some embodiments, a buffer time.

In more detail, one embodiment is directed to a method. A server computer can receive a fulfillment request message associated with an order to deliver an item to an end user by a transporter. The determine an estimated confirmation time, an estimated time for the transporter to arrive at a service provider, an estimated parking and pickup time, and a buffer time. If the preparation time for preparing the item is less than a sum based on the estimated confirmation time, the estimated time for a transporter to arrive at the service provider, the estimated parking and pickup time, and optionally the buffer time, then the server computer can adjust the location and/or size of a geofence. The geofence can trigger sending a second message to the service provider to begin preparing the item when the transporter crosses the geofence.

In some embodiments, if the preparation time estimate for preparing the item is greater than a sum based on an estimated confirmation time, the estimated time for the transporter to arrive at the service provider, the estimated parking and pickup time, and the buffer time, then the server computer can send a first message to the service provider to begin preparing the item before the transporter crosses the geofence.

Another embodiment is directed to a method. A server computer can receive a fulfillment request message associated with an order to deliver an item from a service provider to an end user by a transporter. The server computer can determine a service provider preparation time estimate. In some embodiments, the server computer can determine the service provider preparation time estimate using a first machine learning model, which can comprise a light gradient boosting machine (LGBM). The server computer can determine a transporter time estimate comprising a sum based on a transporter confirmation time estimate, a transporter distance-based time estimate, a transporter parking and pickup time estimate, and in some embodiments, a buffer time. The server computer can compare the transporter time estimate to the service provider preparation time estimate.

If the service provider preparation time estimate is greater than the transporter time estimate, the server computer can transmit a service provider message to a service provider computer associated with the service provider. The service provider message can inform the service provider to prepare the item for retrieval by the transporter. After a time delay, the server computer can transmit a transporter message to a transporter computer associated with the transporter. The transporter message can inform the transporter to retrieve the item from the service provider.

Alternatively, if the service provider preparation time estimate is less than or equal to the transporter time estimate, the service computer can transmit the transporter message to the transporter. The server computer can determine a geofence based on the service provider preparation time estimate and a transporter time estimate (which can be determined using a second machine learning model). The geofence can trigger the server computer to send the service provider message to the service provider computer when the transporter enters a geographic region defined by the geofence. The geofence can be determined based on a product of (1) a difference between the service provider preparation time estimate and the transporter time estimate and (2) an estimated transporter velocity.

Some methods according to embodiments have been demonstrated through experiments to improve the performance of item fulfillment services. In one set of experiments, methods according to embodiments effectively reduced the average total item fulfillment time by approximately 8 to 10 seconds. For item fulfillment services with large numbers of transporters (e.g., hundreds of thousands or millions) performing large numbers of item fulfillments (e.g., tens to hundreds of millions), this improvement can amount to hundreds of thousands of hours of saved transporter time over the course of a year, in addition to improving the end user experience by reducing wait times. Thus, embodiments of the invention have a number of technical advantages which result in operational efficiencies.

Prior to describing embodiments in more detail, it may be helpful to review some terms used throughout this disclosure.

### TERMS

A “server computer” may refer to a computer or cluster of computers. A server computer may be a powerful computing system, such as a large mainframe. Server computers can also include minicomputer clusters or a group of servers functioning as a unit. In one example, a server computer can include a database server coupled to a web server. A server computer may comprise one or more computational apparatuses and may use any of a variety of computing structures, arrangements, and compilations for servicing requests from one or more client computers.

A “client computer” may refer to a computer or cluster of computers that receives some service from a server computer (or another computing system). The client computer may access this service via a communication network such as the Internet or any other appropriate communication network. A client computer may make requests to server computers including requests for data. As an example, a client computer can request a video stream from a server computer associated with a movie streaming service. As another example, a client computer may request data from a database server. A client computer may comprise one or more computational apparatuses and may use a variety of computing structures, arrangements, and compilations for performing its functions, including requesting and receiving data or services from server computers.

A “memory” may refer to any suitable device or devices that may store electronic data. A suitable memory may comprise a non-transitory computer readable medium that stores instructions that can be executed by a processor to implement a desired method. Examples of memories including one or more memory chips, disk drives, etc. Such memories may operate using any suitable electrical, optical, and/or magnetic mode of operation.

A “processor” may refer to any suitable data computation device or devices. A processor may comprise one or more microprocessors working together to achieve a desired function. The processor may include a CPU that comprises at least one high-speed data processor adequate to execute program components for executing user and/or system generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xenon, and/or Xscale; and/or the like processor(s).

A “message” may refer to any information that may be communicated between entities. A message may be communicated by a “sender” to a “receiver,” e.g., from a server computer sender to a client computer receiver. The sender may refer to the originator of the message and the receiver may refer to the recipient of a message. Most forms of digital data can be represented as messages and transmitted between senders and receivers over communication networks such as the Internet.

A “user” may refer to an entity that uses something for some purpose. An example of a user is a person who uses a “user device” (e.g., a smartphone, wearable device, laptop, tablet, desktop computer, etc.). Another example of a user is a person who uses some service, such as a person who uses a delivery service, a member of an online video streaming service, a person who uses a tax preparation service, a person who receives healthcare from a hospital or other organization, etc. A user may be associated with “user data,” data which describes the user or their use of something (e.g., their use of a user device or a service). In some circumstances, a user may be referred to as an “end user.”

A “user device” may be any suitable electronic device that can be used by a user. An exemplary user device can process and communicate information to other electronic devices. The user device may include a processor and a computer-readable medium coupled to the processor, the computer-readable medium comprising code, executable by the processor. The user device may also each include an external communication interface for communicating with other entities. Examples of user devices may include mobile devices such as mobile phones and laptop computers, wearable devices (e.g., glasses, rings, watches, etc.), hardware modules in larger devices such as vehicles (e.g., automobiles), etc.

A “transporter” can be an entity that transports something. For example, a transporter can be a person that transports an item using a transporter vehicle (e.g., a car). In other embodiments, a transporter can be a transporter vehicle that may or may not be operated by a human. Examples of transporter vehicles include cars, boats, scooters, bicycles, drones, airplanes, etc. Transporters can also include autonomous vehicles such as self-driving cars and unmanned drones.

A “fulfillment request” can be a request to provide a resource in response to the fulfillment request. For example, a fulfillment request can include an initial communication from an end user device to a central server computer for a first service provider computer to fulfill a purchase request for a resource, e.g., a purchase request for food from a restaurant. A fulfillment request can include one or more selected items from a selected service provider. A fulfillment request can also include user features of the end user providing the fulfillment request.

An “item” can include an individual article or unit. An item can be a thing that is provided by a service provider. Items can be goods, For example, bowls of soup, soda cans, toys, clothing, etc. An item can be delivered from a service provider location to an end user location by a transporter.

A “feature” can be an individual measurable property or characteristic of a phenomenon. One or more features can be described using a “feature vector,” e.g., a structured list of data (such as numerical data) representing those features. A feature can be input into a model to determine an output. As an example, in pattern recognition and machine learning, a feature vector can comprise an n-dimensional vector of numerical features that represent some object. In some machine learning contexts, a numerical representation of objects facilitate processing and statistical analysis. For image processing, for example, feature values might correspond to the pixels of an image. As another example, when feature vectors represent text, the features may comprise occurrence frequency of textual terms. Feature vectors can be equivalent to the vectors of explanatory variables used in statistical procedures such as linear regression.

“User features” can include attributes or aspects of a user. User features can include features that relate to a user. For example, in the context of a delivery service, user features can include order history, delivery location, dietary preferences, user ratings, user comments, user feedback, saved service providers, favorited service providers, a current location, food category preferences, delivery time thresholds (e.g., deliver within 1 hour, 45 minutes, etc.), budget preferences, and/or other data representative of, or input by, the user.

“Service provider features” can include attributes or aspects of a service provider. Service provider features can include features that relate to a service provider. Service provider features can include service provider details, cuisine, ratings, food category, service provider location(s), item production time, promoted items, item cost, and/or other data representative of the service provider and/or items provided by the service provider.

The term “artificial intelligence model” or “machine learning model” can include a model that may be used to predict outcomes to achieve a pre-defined goal. A machine learning model may be developed using a learning process, in which training data is classified based on known or inferred patterns.

“Machine learning” can include an artificial intelligence process in which software applications may be trained to make accurate predictions through learning. The predictions can be generated by applying input data to a predictive model formed from performing statistical analyses on aggregated data. A model can be trained using training data, such that the model may be used to make accurate predictions. The prediction can be, for example, a classification of an image (e.g., identifying images of cats on the Internet) or as another example, a recommendation (e.g., a movie that a user may like or a restaurant that a consumer might enjoy).

A “machine learning model” may include an application of artificial intelligence that provides systems with the ability to automatically learn and improve from experience without explicitly being programmed. A machine learning model may include a set of software routines and parameters that can predict an output of a process (e.g., identification of an attacker of a computer network, authentication of a computer, a suitable recommendation based on a user search query, etc.) based on feature vectors or other input data. A structure of the software routines (e.g., number of subroutines and the relation between them) and/or the values of the parameters can be determined in a training process, which can use actual results of the process that is being modeled, e.g., the identification of different classes of input data. Examples of machine learning models include support vector machines (SVM), models that classify data by establishing a gap or boundary between inputs of different classifications, as well as neural networks, collections of artificial “neurons” that perform functions by activating in response to inputs. A machine learning model can be trained using “training data” (e.g., to identify patterns in the training data) and then apply this training when it is used for its intended purpose. A machine learning model may be defined by “model parameters,” which can comprise numerical values that define how the machine learning model performs its function. Training a machine learning model can comprise an iterative process used to determine a set of model parameters that achieve the best performance for the model.

### BRIEF DESCRIPTION OF THE DRAWINGS

FIG. 1 shows a system block diagram of an exemplary item fulfillment service system according to some embodiments.

FIG. 2 shows a block diagram of a central server computer 102 according to embodiments.

FIG. 3 shows a flow diagram illustrating an exemplary preparation and delivery method according to embodiments.

FIG. 4 shows a flow diagram illustrating an exemplary preparation and delivery method according to embodiments.

FIG. 5 shows a flow diagram illustrating an exemplary preparation and delivery method according to embodiments.

FIG. 6 shows several timelines associated with different transporter and service provider timings relating to hypothetical item fulfillment requests.

FIG. 7 shows several timelines associated with different transporter and service provider timings relating to hypothetical item fulfillment requests.

### DETAILED DESCRIPTION

In an item fulfillment service (e.g., a delivery service), “providers” (also referred to as “service providers” or “resource providers”) can prepare items for users upon receiving “fulfillment requests” (e.g., orders) from those users. These items can be retrieved by “transporters” (e.g., delivery drivers) who can then transport the items to their respective end users, thereby servicing the fulfillment request. For example, in a food delivery service, a customer (user) can order a meal from a restaurant (service provider). A delivery driver (transporter) can then pick up that meal and drive it to the customer.

There are a variety of ways in which the quality of an item fulfillment service can be evaluated. As an example, users typically prefer to receive items quickly rather than slowly, and as such, the total amount of time it takes for a user to receive their items is a useful metric for evaluating a delivery service. Other factors, such as the correctness of the item fulfillment (e.g., whether the user received the items they requested) are also relevant. Many item fulfillment service organizations are interested in improving both the user experience and the experience of transporters.

For food delivery in particular, item fulfillment service organizations sometimes want to minimize the amount of time between when food preparation is complete and when a customer receives their order. This time period includes the time it takes for a transporter to transport the order to the customer, but also includes the “item wait time” (or “food wait time”), i.e., the amount of time it takes for the transporter to acquire the completed meal itself. Ideally, a completed meal is not waiting at a restaurant for a long time for a transporter to arrive, potentially going cold or otherwise becoming less appetizing. At the same time, item fulfillment service organizations typically want to minimize transporter wait times, i.e., periods of time during which the transporter is waiting for something rather than transporting items to users. In the context of food delivery, this could involve a transporter waiting at a restaurant for the restaurant to finish preparing a meal so that the transporter can deliver that meal to a customer.

Generally it is difficult to minimize both item wait times and transporter wait times. Conceptually, an item fulfillment service organization can minimize item wait times by informing transporters of item fulfillments in advance of service providers. This gives the transporters more time to arrive at the location of service providers, and as such decreases the probability that items (e.g., meals) are waiting on transporter arrival. This reduces item wait times, but likely increases transporter wait times, as it increases the likelihood that a transporter arrives at a service provider before that service provider has completed preparation of any relevant items.

Similarly, an item fulfillment service organization can minimize transporter wait times by informing service providers of item fulfillment before transporters are informed of those item fulfillments. This gives the service providers more time to prepare items, and as such decreases the probability that those items are not ready at the time of transporter arrival. This reduces transporter wait times, but likely increases item wait times, as it increases the likelihood that items are prepared prior to transporter arrival.

These problems are compounded by some of the practical complexities associated with item fulfillment. With food delivery, for example, quick service restaurants (QSRs) or fast casual restaurants may prepare food quickly, while other restaurants may prepare food more slowly, which makes it difficult to precisely time item preparation. Additionally, different transporters may make deliveries at different speeds, e.g., based on their transportation equipment (e.g., a bicycle vs a car), personal driving preferences, knowledge of efficient routes in their particular location, etc. Other factors such as location (e.g., dense high traffic cities vs low traffic suburban areas), or time of day can influence the amount of time it takes for transporters to arrive at service provider locations. As such, it is difficult to minimize both food wait time and transporter wait time under such varied conditions.

Embodiments address these and other problems, individually and collectively.

As described above, one problem that faces item fulfillment services is delayed item preparation times, which increase transporter wait times. Transporter wait times are often a negative experience for transporters because it is time that the transporters could otherwise be using to transport items. Further, some service providers may not want transporters to be waiting for item preparation, e.g., in a small foyer of a service provider restaurant. At the same time however, premature arrival by transporters may increase “item wait times.” In the context of food delivery, these could correspond to times when prepared food is sitting on the counter getting cold before a transporter arrives to retrieve it.

In many item fulfillment services, service providers begin preparing items prior to transporter arrival, e.g., after they confirm an item fulfillment order. Different service providers prepare items at different times and different rates, sometimes due to other pending item fulfillment orders, or due to the particular nature of the items being prepared. In some cases, service providers may wait for transporter arrival to prepare items, which may cause higher wait times for transporters.

After an item fulfillment order is confirmed by a service provider, a matching process can be used to identify transporters that can transport the item from the service provider to an end user. Once a transporter accepts the order, they can be travelling to the service provider, and can be notified when the order is ready for pickup.

In the case of quick service providers, e.g., “quick service restaurants” (i.e., restaurants that generally require low food preparation times and are more sensitive to food (item) wait times), service providers sometimes only begin preparing items only after the transporter has arrived, to ensure the quality of the item upon delivery. This can result in higher transporter wait times and longer delivery times. Techniques such as Auto Order Release (AOR) have been used to address these issues.

In AOR, service providers typically confirm item fulfillment orders, but typically hold off on preparing any relevant items until the transporter is at a certain distance from the service provider. These distances can be determined using geolocation indicators and can be called “release distances,” which can be used to generate a predefined “geofence.” A “geofence” can be a virtual geographic boundary, e.g., defined by GPS or RFID technology, which enables software to trigger a response when a mobile device enters or leaves a particular area. For example, when the transporter enters or crosses the predefined geofence, a message can be sent to the service provider to begin preparing the item for retrieval by the transporter. The geofence can take any suitable shape. For example, the geofence can be a circle or other shape surrounding a service provider. In other embodiments, the geofence may be defined by travel time down roads or streets leading to the service provider.

In some cases, service providers work with item fulfillment service organizations to determine if AOR techniques are applicable or useful for their particular service. Further, service providers can work with item fulfillment service organizations to define a static release distance or a static geofence based on their particular item preparation needs. While this process generally reduces item wait times, it can increase transporter wait times, e.g., if a service provider needs more time to prepare an item than initially anticipated. Further, the “hard-coded” nature of the static release distances and static geofences does not enable order releases to be adjusted based on factors such as transporter travel time and service provider item preparation times. AOR techniques can sometimes be difficult to scale to larger numbers of service providers, as geofences are manually defined for each service provider individually. Further, AOR techniques can generally result in more transporters waiting at service providers.

Embodiments of the present disclosure improve AOR techniques by moving away from “hard-coded” distances and static geofences towards dynamic systems that can be used to reduce transporter wait times. Such systems can dynamically determine improved item fulfillment order release times for individual item fulfillment orders. A server computer can use features such as item fulfillment parameters (e.g., subtotal, item count, etc.) and service provider parameters to reduce item wait times and transporter wait times, as described below.

Methods according to embodiments can enable a server computer to decide, for each item fulfillment order if the item fulfillment order should be immediately (or quickly) released to a service provider or if the order should be placed on a delayed release (e.g., according to the AOR techniques described above). Further, methods according to embodiments can use a machine learning model to estimate the time needed for AOR-enabled service providers to prepare items. The server computer can further use machine learning models to define improved geofences, which better time the preparation of items and the travel time of transporters. In summary, a server computer can use methods disclosed herein, including the use of machine learning, to optimize when service providers should start preparing items and when transporters should travel to service providers in order to retrieve those items for delivery. The server computer can aim to minimize the difference between the transporter's arrival time and the item preparation time.

The server computer can use a set of conditions to trigger timing decisions for each item fulfillment order. For example, larger item fulfillment orders typically take longer to prepare. If the server computer predicts (e.g., using a machine learning model) that the required item preparation time is longer than a threshold, releasing the item fulfillment order to the service provider quickly will allow more time for the service provider, and therefore reduce transporter wait time. As described in more detail below, an experiment was conducted with service providers that typically experienced higher transporter wait times. During this experiment, it appeared that methods according to embodiments resulted in a lower wait time for transporters. The server computer deciding on a release strategy for each item fulfillment resulted in higher item preparation time item fulfillments being released earlier, giving service providers more time to prepare items.

The server computer can use a set of predictors to estimate the time needed for a service provider to prepare items versus the time needed for a transporter to arrive at the service provider to retrieve those items. A “Light Gradient Boosting Machine” (LGBM) item preparation time machine learning model tuned for AOR item fulfillments can be used for this purpose. An advantage of LGBM is that the loss function can be adjusted to bias and tune the model's performance based on the needs of item fulfillment service organizations.

Additionally, the server computer can use machine learning for transporter speed estimation, which can be used to predict the amount of time it takes a transporter to arrive at a service provider in order to retrieve prepared items. The use of machine learning for this purpose can further improve accuracy of methods according to embodiments. This transporter speed estimation machine learning model does not need to depend on transporter specific features (e.g., what type of vehicle the transporter is using for transportation), but can be further improved by the use of these features. However, such features can change somewhat frequently, and there is no guarantee that a model will have access to all relevant features at all times. Default values can be defined so that a prediction can be produced, even without access to these features.

The server computer can access relevant machine learning prediction services (e.g., the “Sibyl” prediction service) using an API or a client (e.g., the gRPC Hermes client). In some embodiments, machine learning models can be used to produce four different estimations or prediction values, including an item preparation time prediction value (relating to the predicted amount of time required for a service provider to prepare an item), a parking prediction value (relating to the predicted amount of time required for a transporter to find parking), a D2R prediction value (relating to the predicted amount of time required for the transporter to get to the service provider from their current location based on distance), and a CONFLAT prediction value (based on the predicted amount of time required for a transporter to confirm an order after an order is requested by an end user).

The features used by the machine learning models can include a mix of numerical, categorical, and item fulfillment level features. Some of these features can be aggregated at a granularity of a week or a month, while others can be computed at a granularity of an hour. While many of these features are aggregated, some numerical and categorical features can be used that are specific to individual item fulfillments. For example, a subtotal, a service provider identifier, item count, etc.

The server computer can attempt to balance an equation such as the following:

$$prep time > CONFLAT + D 2 R + parking and pickup + buffer$$

The above equation compares a sum of at least (i) a determined (e.g., predicted) transporter confirmation time (or the amount of time from when an order is placed by an end user to the time that an item fulfillment is accepted by a transporter) (CONFLAT), (ii) a determined (e.g., predicted) transporter travel time to the service provider (D2R), (iii) an estimated parking and pickup time (the time it takes for a transporter to park near the service provider and walk to retrieve the ordered item(s)) (“parking and pickup”), and (iv) an optional buffer time (“buffer”) to the preparation time estimate (“prep time”) to the one or more items ordered by the end user (“prep time”). In some embodiments, an LGBM model can be used to predict the item preparation time estimate (prep time), and a travel speed model used to predict or determine the transporter's estimated travel time to the service provider. The server computer can determine a geofence based on the transporter's geolocation and their travel speed, e.g., in order to time the transporter's arrival and completion of item preparation. Once the transporter crosses the geo-fence, a signal or notification can be sent to the service provider to begin preparing the one or more items ordered by the end user. In some embodiments, the buffer time can be adjusted to tune the performance of the system based on desired performance metrics. For example, for some item fulfillment service organizations, longer transporter wait times may be preferable over longer item wait times.

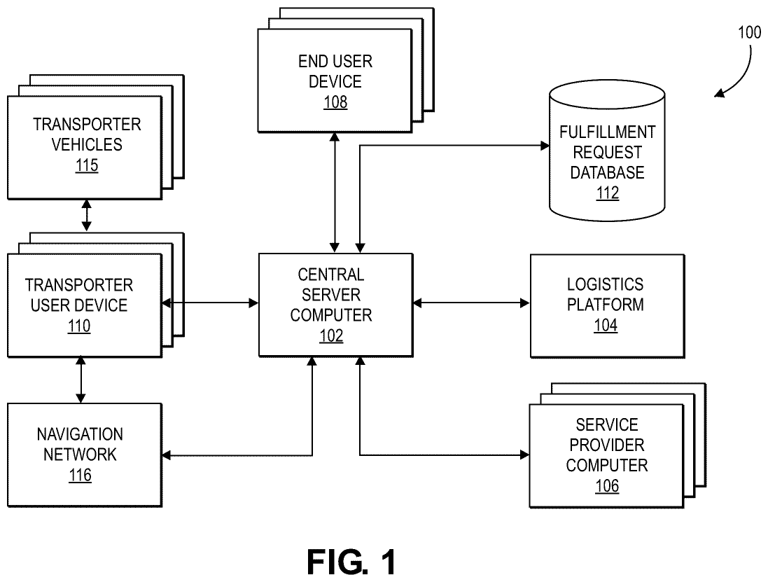

FIG. 1 shows a system 100 according to some embodiments of the present disclosure. The system 100 can comprise one or more end user devices 108, a central server computer 102 (sometimes referred to more generically as a “server computer”), a fulfillment request database 112, a logistics platform 104, one or more transporter user devices 110 (sometimes referred to as “transporter device” or “transporter computers”), and a navigation network 116. FIG. 1 also shows one or more transporter vehicles 115, which may be operated by “transporters”, e.g., users of the transporter user devices 110. As an example, a transporter can be a delivery person, a transporter user device (or transporter computer) 110 can comprise that delivery person's mobile phone, and a transporter vehicle 115 can be a car that is operated by the delivery person. In some cases, a transporter can be an autonomous vehicle and a transporter user device can be a communication device in the autonomous vehicle.

For simplicity of illustration, a certain number of components are shown in FIG. 1. It should be understood, however, that embodiments of the present disclosure may include more than one of each component. In addition, some systems according to embodiments of the present disclosure may include a lesser number of components or a greater number of components than those shown in FIG. 1.

The central server computer 102 can be in operative communication with the one or more end user devices 108, the fulfillment request database 112, the logistics platform 104, the one or more service provider computers 106, the transporter user device 110, and in some embodiments, the navigation network 116. Further, the one or more transporter user devices 110 can be in operative communication with the navigation network 116. These devices and computers can communicate with one another by sending messages over a communications network (not pictured). Messages between at the devices in system 100 can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583) and/or the like.

A communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

In more detail, the one or more end user devices 108 can include devices operated by end users (sometimes more generically referred to as “users”). The one or more end user devices 108 can generate and provide fulfillment request messages to the central server computer 102. A fulfillment request message can indicate that a request (e.g., a request for a service, or a request for an item, such as a meal to be delivered) can be fulfilled by one or more service providers operating the one or more service provider computers 106.

The central server computer 102 can be a server computer. The central server computer 102 can maintain and operate a platform. The platform can be a delivery platform that delivers items offered by service providers to end users via transporters. Illustratively, a service provider may be a restaurant that sells pizza. The central server computer 102 can be operated by a food delivery organization that can aid in the delivery of pizza via transporters to end users that seek to purchase the pizza from the restaurant using the central server computer 102.

The central server computer 102 can facilitate the fulfillment of fulfillment requests received from the one or more end user devices 108. For example, the central server computer can identify a transporter, corresponding to a transporter user device 110 that can satisfy the fulfillment request based on any suitable criteria (e.g., transporter location, service provider location, end user destination, end user location, transporter mode of transportation, etc.). The logistics platform 104 may provide real time data regarding locations of the various service providers, transporters, and end users to the central server computer 102.

The fulfillment request database 112 can store data related to previous (e.g., historical) fulfillment requests. For example, after a fulfillment request is fulfilled, the central server computer 102 can store fulfillment request data in the fulfillment request database 112. For example, the central server computer 102 can store any spatial-temporal fulfillment data (e.g., transporter user device locations over time, transporter user device motion data over time, length of time taken to fulfill the fulfillment request, a fulfillment time, a fulfillment location, etc.), fulfillment service data (e.g., fulfilled services, an amount, a service provider computer identifier, an end user device identifier, a transporter user device identifier, etc.), and any other data relating to the fulfillment request and/or the fulfillment of the fulfillment request.

The one or more service provider computers 106 can include computers operated by service providers. For example, a service provider computer can be a food provider computer that is operated by a food provider (e.g., a restaurant, grocery store, convenience store, etc.). Service providers can use the one or more service provider computers 106 to offer to provide services to the end users of the one or more end user devices 108. A service provider computer 106 can receive requests to prepare one or more items for delivery from the central server computer 102. The service provider computer can initialize the preparation of the one or more items so that they can be delivered to an end user of an end user device 108 by a transporter user of a transporter user device 110.

The one or more transporter user devices 110 can be devices (e.g., computers) operated by transporters. As examples, the one or more transporter user devices 110 can be smartphones, wearable devices, personal assistant devices, etc. A transporter can request to fulfill an end user's fulfillment request. For example, the transporter user device 110 can generate and transmit a request to fulfill a particular end user's fulfillment request to the central server computer 102. The central server computer 102 can notify the transporter user device 110 of the fulfillment request. The transporter user device 110 can respond to the central server computer 102 with a request to perform the delivery to the end user as indicated by the fulfillment request.

The navigation network 116 can provide navigational directions to the one or more transporter user devices 110. For example, a transporter user device 110 can obtain a location from the central server computer 102. The location can be a service provider parking location, a service provider location, an end user parking location, an end user location, etc. The navigation network 116 can provide navigational data that can be used to navigate to the location. For example, the navigation network 116 can be a global positioning system that provides location data to the transporter user device 110.

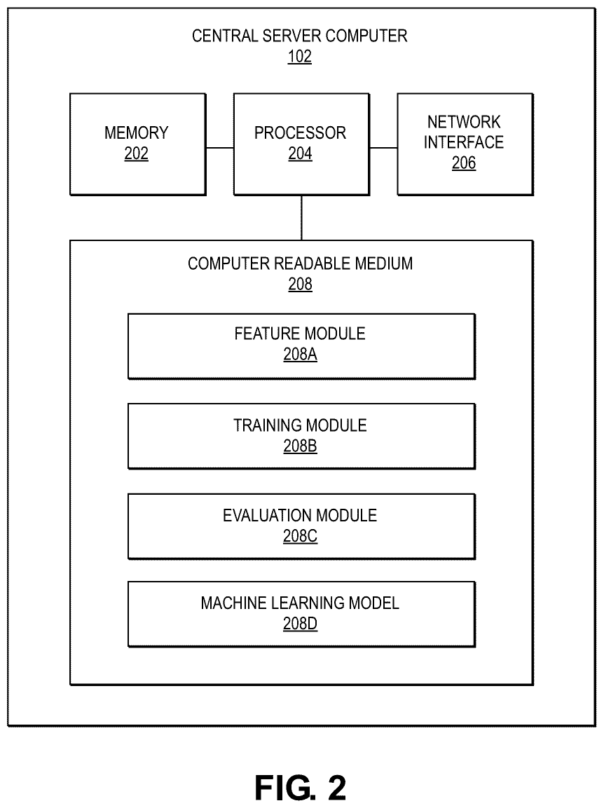

FIG. 2 shows a block diagram of a central server computer 102 according to embodiments. The central server computer 102 may comprise a processor 204. The processor 204 may be coupled to a memory 202, a network interface 206, and a computer readable medium 208. The computer readable medium 208 can comprise a feature module 208A, a training module 208B, an evaluation module 208C, and a machine learning module 208D.

The memory 202 can be used to store data and code. For example, the memory 202 can store input data, features, machine learning models, weights, etc. The memory 202 may be coupled to the processor 204 internally or externally (e.g., cloud based data storage), and may comprise any combination of volatile and/or non-volatile memory, such as RAM, DRAM, ROM, flash, or any other suitable memory device.

The computer readable medium 208 may comprise code, executable by the processor 204, for performing a method comprising: receiving, by a server computer, a fulfillment request message associated with an order to deliver an item to an end user by a transporter; determining, by the server computer, a transporter time estimate, wherein the transporter time estimate is based on a sum based on an estimated confirmation time, an estimated time for the transporter to arrive at a service provider, and an estimated parking and pickup time associated with the order; and if a preparation time estimate for preparing the item is less than or equal to the transporter time estimate, then adjusting, by the server computer a location of a geofence that will trigger sending a second message to the service provider to begin preparing the item when the transporter crosses the geofence.

The feature module 208A may comprise code or software, executable by the processor 204, for determining and/or evaluating features. The feature module 208A, in conjunction with the processor 204, can extract features from a dataset. Feature extraction can start from an initial set of measured data (e.g., data from the dataset). The feature module 208A, in conjunction with the processor 204, can obtain the dataset from a memory or database. The feature module 208A, in conjunction with the processor 204, can build derived values (e.g., features) from the dataset that can be intended to be informative and non-redundant, facilitating the subsequent learning and generalization steps, and in some cases leading to better human interpretations. Feature extraction can be related to dimensionality reduction of the dataset.

When the input data to an algorithm is too large to be processed and it is suspected to be redundant (e.g., the same measurement in both feet and meters, or the repetitiveness of images presented as pixels), then it can be transformed into a reduced set of features (also named a feature vector). Determining a subset of the initial features is called feature selection. The selected features can contain the relevant information from the input data, so that the desired task (e.g., determining predicted values and predicted ranks) can be performed by using this reduced representation instead of the complete initial data.

The feature module 208A, in conjunction with the processor 204, can perform feature extraction/dimensionality reduction techniques including independent component analysis, isomap creation, principle component analysis, latent semantic analysis, partial least squares, multifactor dimensionality reduction, nonlinear dimensionality reduction, embedding, autoencoders, etc.

The training module 208B can include may comprise code or software, executable by the processor 204, for training machine learning model(s). The process of training a machine learning model involves providing a machine learning algorithm with training data to learn from. The training module 208B, in conjunction with the processor 204, can input training data into the machine learning model for training. The training data can include labels that indicate the target attribute of the data.

The training module 208B, in conjunction with the processor 204, can aid the learning algorithm in finding patterns in the training data that map the input data attributes to the target. The training module 208B, in conjunction with the processor 204, can output a trained machine learning model that captures these patterns.

The training module 208B, in conjunction with the processor 204, can further train the trained machine learning model with additional training data that may be obtained after the initial training is complete. The training module 208B, in conjunction with the processor 204, can continuously train the trained machine learning model over time.

The evaluation module 208C can include may comprise code or software, executable by the processor 204, for evaluating data and machine learning model(s). The evaluation module 208C, in conjunction with the processor 204, can utilize the trained machine learning model to obtain predictions on new data for which the target (e.g., the predicted value and the predicted rank) are unknown. The evaluation module 208C, in conjunction with the processor 204, can input historical data into the trained machine learning model for evaluation. The trained machine learning model can output an estimated confirmation time, an estimated time for the transporter to arrive at a service provider, and an estimated parking and pickup time.

The machine learning module 208D can include any of the above described machine learning models including neural networks, support vector machines, LGBM, etc.

The network interface 206 may include an interface that can allow the central server computer 102 to communicate with external computers. The network interface 206 may enable the central server computer 102 to communicate data to and from another device (e.g., the logistics platform 104, the one or more service provider computers 106, the end user device 108, the transporter user device 110, etc.). Some examples of the network interface 206 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 206 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 206 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

In some embodiments, the central server computer 102 may be in operative communication with one or more databases. For example, the central server computer 102 can communicate with a dataset database and/or a features database. The databases may be conventional, fault tolerant, relational, scalable, secure databases such as those commercially available from Oracle™ or Sybase™.

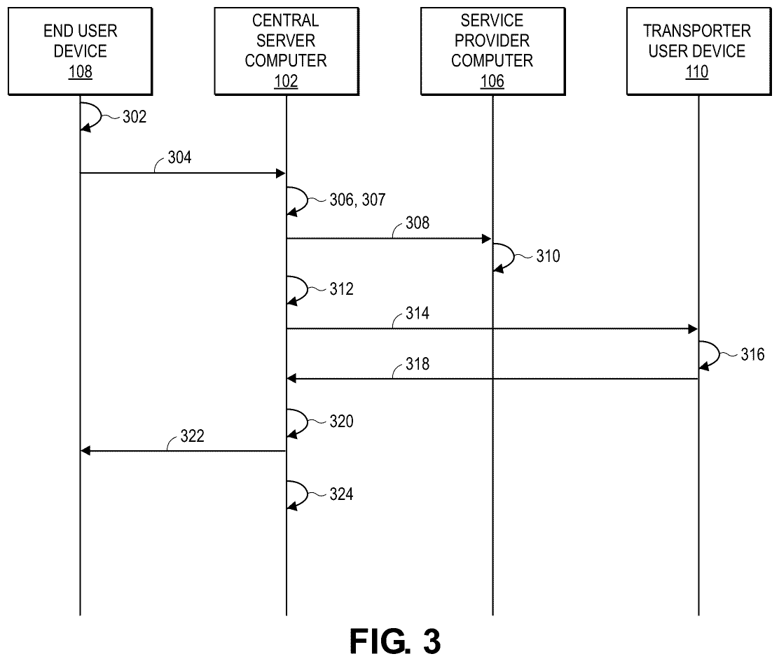

FIG. 3 shows a flow diagram illustrating an exemplary preparation and delivery method according to embodiments, wherein a geofence is not applied. The method illustrated in FIG. 3 will be described in the context of the central server computer 102 receiving a fulfillment request message from the end user device 108 to fulfill preparation and delivery of one or more items from a cart to the end user of the end user device 108. The central server computer 102 can communicate with the service provider computer 106 and the transporter user device 110 to fulfill the fulfillment request.

At step 302, the end user device 108 can decide to check out with a cart in a central server computer application installed on the end user device 108. The cart can include one or more items that are provided from a service provider of the service provider computer 106.

At step 304, after checking out with the cart, the end user device 108 can provide a fulfillment request message including the one or more items from the cart to the central server computer 102. The fulfillment request message can also include a service provider computer identifier that identifies the service provider computer 106.

At step 306, after receiving the fulfillment request message, the central server computer 102 can perform a transaction process with the end user device 108. For example, the central server computer 102 can communicate with a payment network to process the transaction for the one or more items. The central server computer 102 can receive an indication of whether or not the transaction is authorized. If the transaction is authorized, then the central server computer 102 can proceed with step 307.

At step 307, the central server computer can determine a geofence will not be applied to the order. For example, the central server computer can determine whether or not it is likely that the time it takes the service provider to prepare the one or more items will take less time (e.g., substantially less time) than it will likely take a transporter to arrive at the service provider to retrieve the one or more items. In some embodiments, this determination can be based on part on the type of service provider that is preparing the items. For example, if the service provider is a full service restaurant that takes 30-40 minutes to prepare food or a convenience store that prepare items for purchase, then the server computer can automatically determine that no dynamic geofence will be applied. This is because the transporter is either likely to arrive at the service provider before the item is prepared or item preparation time is not relevant. On the other hand, if the service provider is a QSR, then it is likely that transporter will arrive at the service provider well after the item is prepared if the QSR is asked to prepare the item at the same time that the transporter is notified to retrieve the item from the service provider.

At step 308, if a dynamic geofence will not be applied, then the central server computer 102 can instantly release the order to the service provider computer 106. The central server computer 102 can provide the fulfillment request message, or a derivation thereof, to the service provider computer 106. The central server computer 102 can determine which service provider computer of a plurality of service provider computers to communicate with based on the service provider indicated in the fulfillment request message. For example, the fulfillment request message can indicate that the one or more items are provided by the service provider of the service provider computer 106. The central server computer 102 can identify the service provider computer 106 using the service provider computer identifier in the fulfillment request message.

At step 310, after receiving the fulfillment request message, the service provider computer 106 can initiate preparation of the one or more items. For example, the service provider computer 106 can alert service providers (e.g., those preparing the items) at the service provider location. The service providers can prepare the one or more items for pick up by a transporter.

At step 312, after providing the fulfillment request message to the service provider computer 106, the central server computer 102 can determine one or more transporters operating one or more user devices that are capable of fulfilling the fulfillment request message. The central server computer 102 can determine the one or more transporters from the transporter user devices. The central server computer 102 can determine the one or more transporter user devices based on whether or not the transporter user device is online, whether or not the transporter user device is already fulfilling a different fulfillment request message, a location of the transporter user device, etc.

At step 314, after determining the one or more transporter user devices, the central server computer 102 can provide the fulfillment request message, or a derivation thereof, to the one or more transporter user devices including the transporter user device 110.

At step 316, after receiving the fulfillment request message, the transporter of the transporter user device 110 can determine whether or not they want to perform the fulfillment. The transporter can decide that they want to perform the delivery of the one or more items from the service provider location to the end user location. The transporter user device 110 can generate an acceptance message that indicates that the fulfillment request is accepted.

At step 318, after generating the acceptance message, the transporter user device 110 can provide the acceptance message to the central server computer 102.

After providing the acceptance message to the central server computer 102, the transporter user device 110 can communicate with the navigation network 116 and the transporter can proceed to the service provider location to obtain the one or more items. The transporter user device 110 can then receive input from the transporter that indicates that the transporter obtained the one or more items (e.g., the transporter selects that they picked up the items). The transporter user device 110 can then communicate with the navigation network 116 and the transporter can then proceed to the end user location to provide the one or more items to the end user. In some embodiments, the transporter user device 110 can provide update messages to the central server computer 102 that include a transporter user device 110 location and/or event data (e.g., items picked up, items delivered, etc.).

In some embodiments, after receiving the acceptance message, the central server computer 102 can notify the other transporter user devices that received the fulfillment request message that the fulfillment request is no longer available.

At step 320, at any point after receiving the acceptance message, the central server computer 102 can check the status of the fulfillment request. For example, the central server computer 102 can determine the location of the transporter user device 110 and can determine an estimated amount of time for the transporter user device 110 to arrive at the end user location.

At step 322, the central server computer 102 can provide an update message to the end user device 108 that includes data related to the fulfillment of the fulfillment request message. The data can include an estimated amount of time, the transporter user device location, event data (e.g., items picked up from the service provider), and/or other data related to the fulfillment of the fulfillment request message.

At step 324, the central server computer 102 can store any data received, sent, and/or processed during the fulfillment of the fulfillment request message into a database. For example, the central server computer 102 can store a user's cart selection as user features into a user feature database.

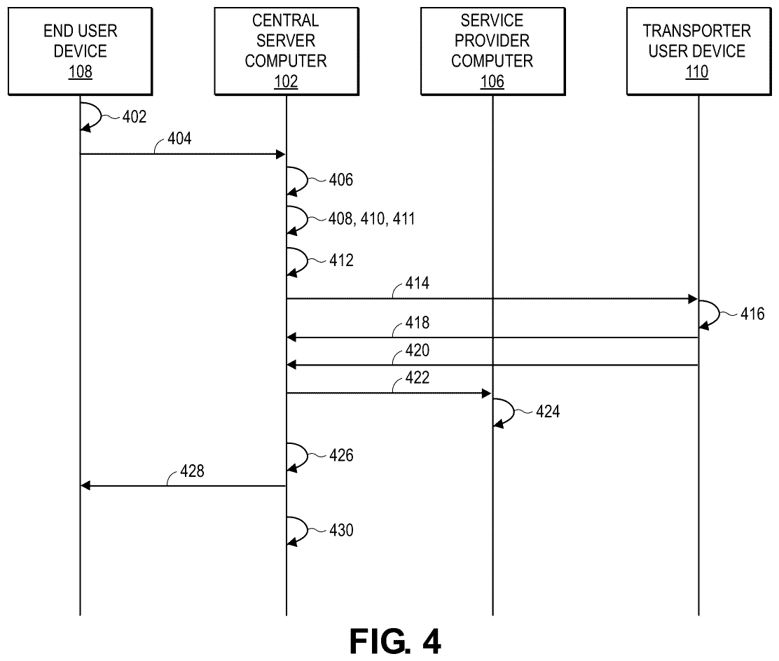

FIG. 4 shows a flow diagram illustrating an exemplary preparation and delivery method according to embodiments, where the service provider of service provider computer 106 is a QSR, and the time that is takes to prepare a requested item is short.

In this example, the central server computer 102 determines that a geofence is to be applied, adjusts the location of the geofence, and transmits a transporter message to the transporter user device 110. Once the transporter user device 110 crosses the geofence, the central server computer 102 transmits a second message to the service provider computer 106 to begin preparing the item. If the service provider were to begin preparing the item at the same time that the transporter departs to retrieve the item, the item may be ready long before the transporter arrives. On the other hand, if the service provider waits until the transporter has arrived before beginning to prepare the item, the transporter may be unnecessarily spend time waiting for the service provider to prepare the item. By setting a geofence that will trigger sending a second message to the service provider to begin preparing the item when the transporter crosses the geofence, embodiments can minimize item wait time (the time that the item is waiting to be retrieved by the transporter) without introducing transporter wait time. Embodiments can set a geofence that will trigger sending a second message to the service provider to begin preparing the item when the transporter crosses the geofence. The geofence is “dynamic” in the sense that it will be different for various item orders, as orders can have different types of service providers, different items that have different preparation times, different transporters that are available at different times, etc.

In the flow in FIG. 4, steps 402-406 can be similar to steps 302-306 of FIG. 3, and the descriptions thereof can be incorporated herein.

At step 408, after receiving the fulfilment request message from the end user device 108, the central server computer 102 can determine that a geofence is to be potentially applied. For example, the central server computer 102 can determine that a geofence is to be applied to the fulfillment request, because the service provider identified in the fulfillment request is a QSR that takes on average 5 minutes to prepare its items, but that there are currently no transporters within a 20 minute radius of the service provider.

At step 410, if the central server computer 102 determines that the geofence is to be potentially applied, then responsive to receiving the fulfilment request message, the central server computer 102 can use machine learning to determine a transporter time estimate comprising a sum based on an estimated confirmation time (CONFLAT), an estimated time for the transporter to arrive at a service provider (D2R), and an estimated parking and pickup time (parking and pickup). The central server computer 102 may also determine a preparation time estimate for preparing the items using a “Light Gradient Boosting Machine” (LGBM) item preparation time machine learning model tuned for AOR item fulfillments.

At step 411, the central server computer 102 can compare the preparation time estimate for preparing the item(s) to the transporter time estimate. If the preparation time estimate for preparing the item(s) is less than or equal to the transporter time estimate, then the central server computer 102 can adjust the location of the geofence. For example, if the item preparation time estimate is much shorter (e.g., 5 minutes) than the transporter time estimate (e.g., 25 minutes), it is desired to delay the preparation of the item to minimize item wait time. The central server computer 102 may adjust the location of the geofence to be closer to the service provider location, so that the service provider does not begin preparing the item until the transporter is nearby (e.g., 5 minutes from the service provider). The precise location of the geofence can be determined using the service provider's location, the transporter's geolocation and their travel speed. As an example, if the preparation time estimate is 10 minutes, and the transporter time estimate is 20 minutes, then the geofence would be implemented around the service provider's location based on the difference between 20 minutes and 10 minutes. Assuming that the transporter's average speed in the direction of the service provider is 30 miles per hour, the geofence would be set to be 5 miles from the service provider location (e.g., 0.167 hours*30 miles per hour).

At step 412, before or after adjusting the location of the geofence, the central server computer 102 can determine one or more transporters operating one or more user devices that are capable of fulfilling the fulfillment request message.

At step 414, after determining the one or more transporter user devices, the central server computer 102 can provide the fulfillment request message, or a derivation thereof, to the one or more transporter user devices including the transporter user device 110.

At step 416, after receiving the fulfillment request message, the transporter of the transporter user device 110 can determine whether or not they want to perform the fulfillment. The transporter user device 110 can generate an acceptance message that indicates that the fulfillment request is accepted.

At step 418, after generating the acceptance message, the transporter user device 110 can provide the acceptance message to the central server computer 102.

After providing the acceptance message to the central server computer 102, the transporter user device 110 can communicate with the navigation network 116 and the transporter can proceed to the service provider location to obtain the one or more items.

At step 420, the transporter user device 110 can transmit a second message to the central server computer 102 as soon as the transporter crosses the geofence.

At step 422, after receiving the second message from the transporter user device 110 indicating that the transporter has crossed the geofence, the central server computer 102 can provide the fulfillment request message, or a derivation thereof, to the service provider computer 106.

At step 424, after receiving the fulfillment request message, the service provider computer 106 can initiate preparation of the one or more items.

The transporter user device 110 can then receive an input from the transporter that indicates that the transporter obtained the one or more items and are now traveling to the end user operating the end user device 108.

At step 426, at any point after receiving the acceptance message, the central server computer 102 can check the status of the fulfillment request.

At step 428, the central server computer 102 can provide an update message to the end user device 108 that includes data related to the fulfillment of the fulfillment request message.

At step 430, the central server computer 102 can store any data received, sent, and/or processed during the fulfillment of the fulfillment request message into a database.

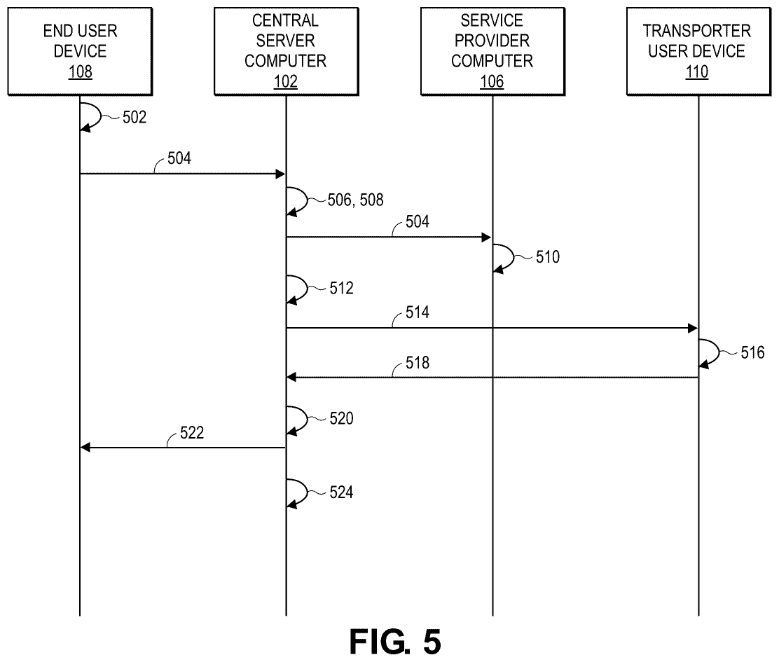

FIG. 5 shows a flow diagram illustrating an exemplary preparation and delivery method according to embodiments, wherein the service provider operating the service provider computer 106 is likely to take a long time to prepare items requested by an end user.

In FIG. 5, steps 502-506 may be similar to steps 302-306 in FIG. 3, and the descriptions thereof can be incorporated herein.

At step 508, the central server computer 102 can compare a preparation time estimate for preparing the item(s) to the transporter time estimate associated with the order as described above. In this scenario, the central server computer 102 may determine that the preparation time estimate for preparing the item(s) is greater than the transporter time estimate. For example, the estimated transporter time may be 10 minutes, while the preparation time estimate may be 20 minutes.

At step 509, if the preparation time estimate for preparing the item(s) is greater than the transporter time estimate, then the central server computer 102 can send a first message to the service provider computer 106 to begin preparing the item. The central server computer 102 can provide the fulfillment request message, or a derivation thereof, to the service provider computer 106. In some embodiments, the central server computer 102 may transmit the first message to the service provider computer 106 immediately upon determining that the preparation time estimate is greater than the transporter time estimate.

At step 510, after receiving the fulfillment request message, the service provider computer 106 can initiate preparation of the one or more items.

At step 512, after providing the fulfillment request message to the service provider computer 106, the central server computer 102 can determine one or more transporters operating one or more user devices that are capable of fulfilling the fulfillment request message. The central server computer 102 may determine the one or more transporters after a time delay in order to minimize the transporter wait time. Otherwise, if the transporter departs to retrieve the item(s) and the item preparation time estimate is substantially greater than the transporter time estimate, then the transporter may arrive before the item(s) are prepared. For example, if the time needed to prepare the item(s) requested by the end user takes 20 minutes to prepare, but it will take potential transporters an estimated 10 minutes to arrive at the service provider, then the transmission of the fulfillment request messages or derivatives thereof can be sent to candidate transporters operating transporter user devices after a 10 minute delay.

At step 514, after determining the one or more transporter user devices, the central server computer 102 can provide the fulfillment request message, or a derivation thereof, to the one or more transporter user devices including the transporter user device 110.

At step 516, after receiving the fulfillment request message, the transporter of the transporter user device 110 can determine whether or not they want to perform the fulfillment.

At step 518, after generating the acceptance message, the transporter user device 110 can provide the acceptance message to the central server computer 102.

After providing the acceptance message to the central server computer 102, the transporter user device 110 can communicate with the navigation network 116 and the transporter can proceed to the service provider location to obtain the one or more items.

At step 520, at any point after receiving the acceptance message, the central server computer 102 can check the status of the fulfillment request.

At step 522, the central server computer 102 can provide an update message to the end user device 108 that includes data related to the fulfillment of the fulfillment request message.

At step 524, the central server computer 102 can store any data received, sent, and/or processed during the fulfillment of the fulfillment request message into a database.

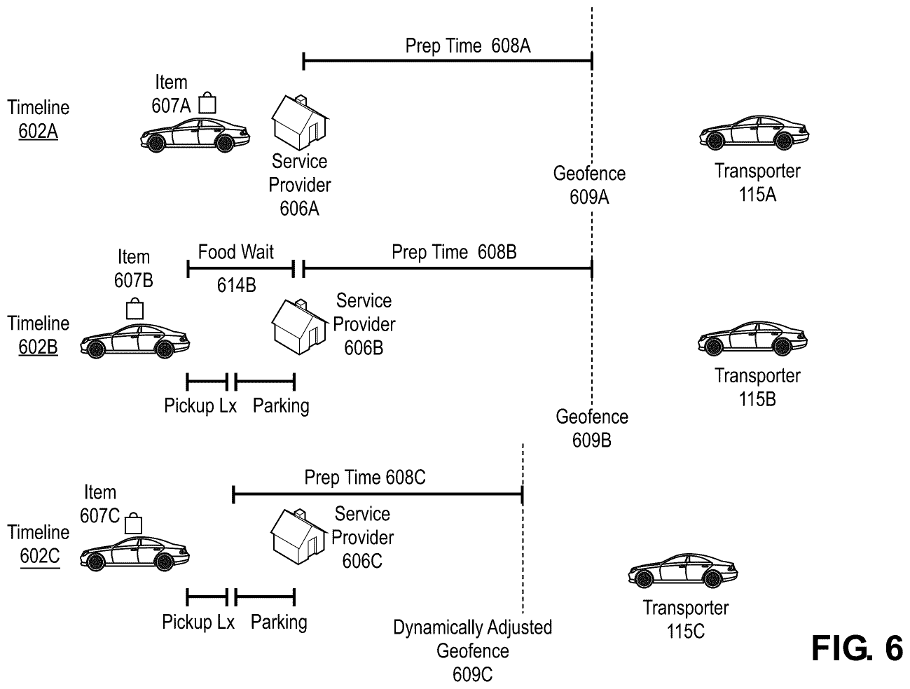

FIG. 6 shows three item fulfilment timelines 602A, 602B, and 602C. In each timeline, the transporter may have received a transporter message from the service provider computer to retrieve an item from a service provider. Once the transporters 115A-C cross geofences 609A-C, service providers 606A-C may receive an item fulfilment request message to begin preparing items 607A-C.

Timeline 602A illustrates an expected timeline for transporter 115A retrieving item 607A from service provider 606A. In this case, the item fulfilment request is transmitted to the service provider 606A once the transporter 115A crosses a hard coded geofence 609A. The hard-coded geofence 609A is set at a location that is the item preparation time 608A away from the service provider 606A. In this way, it is expected that the time that it takes transporter 115A to travel from the geofence 609A to the service provider 606A is equal to the item preparation time 608A, and the item 607A is ready at the same time the transporter 115A arrives. The expected result is that transporter 115A can leave with item 607A without having to wait at the service provider 606A, and the item 607A is not prepared too early since it may lose quality the longer it sits out. However, timeline 602A fails to address external factors such as parking, and therefore is not realistic.

Timeline 602B illustrates a more realistic result of using a hard-coded geofence 609B. Geofence 609B may be configured in a similar way to geofence 609A, such that it is exactly the item preparation time 608B away from service provider 606B. Timeline 602B illustrates that when implementing a geofence that is configured to be exactly the item preparation time away from the service provider, an item wait time 614B is introduced.

For example, item 607B may be ready at the same time that the transporter 115B arrives at the service provider 606B. However, transporter 115B does not retrieve the item 607B immediately. External factors such as parking time and pickup time may increase the time it takes for transporter 115B to retrieve item 607B from service provider 606B. In some embodiments, while the transporter 115B is parking, the item 607B is already prepared. In this case, the item has been prepared too soon. The item 607B may sit out for an item wait time 614B until the transporter 115B can retrieve the item 607B. Item wait time may be associated with poor item quality, and should be minimized.

To address this problem, embodiments can dynamically adjust the location of the geofence. Embodiments can determine a transporter time estimate. The transporter time estimate may provide a better prediction as to when the transporter will retrieve the item by accounting for external factors such as parking time. Specifically, the transporter time estimate can comprise a sum based on an estimated confirmation time (CONFLAT), an estimated time for the transporter to arrive at a service provider (D2R), and an estimated parking and pickup time, and in some embodiments, a buffer time. If the item preparation time is less than or equal to the transporter time estimate, then embodiments can adjust the location of the geofence. When the transporter crosses the geofence, embodiments can transmit a message to the service provider to begin preparing the item.

Embodiments may determine the size and/or location of the geofence based on the difference between the transporter time estimate and the item preparation time, thereby reducing item wait times.

Timeline 602C illustrates how embodiments can eliminate item wait times. In timeline 602C, the dynamically adjusted geofence 609C can be a difference between the transporter time estimate and the item preparation time away from service provider 606C. In effect, the dynamically adjusted geofence 609C may trigger the fulfilment request message to be transmitted to the service provider when the transporter 115C is closer to the service provider 606C (as compared to timelines 602A, 602B). As shown in timeline 602C, the parking time 614C may overlap with the item preparation time 608C. For example, the service provider 606C may be preparing the item while the transporter 115C is parking. As a result, the item is ready once the transporter 115C is finished parking, and the item 607C does not sit out and lose quality (e.g., become cold or stale). The item 607C is fresh when the transporter 115C retrieves it.

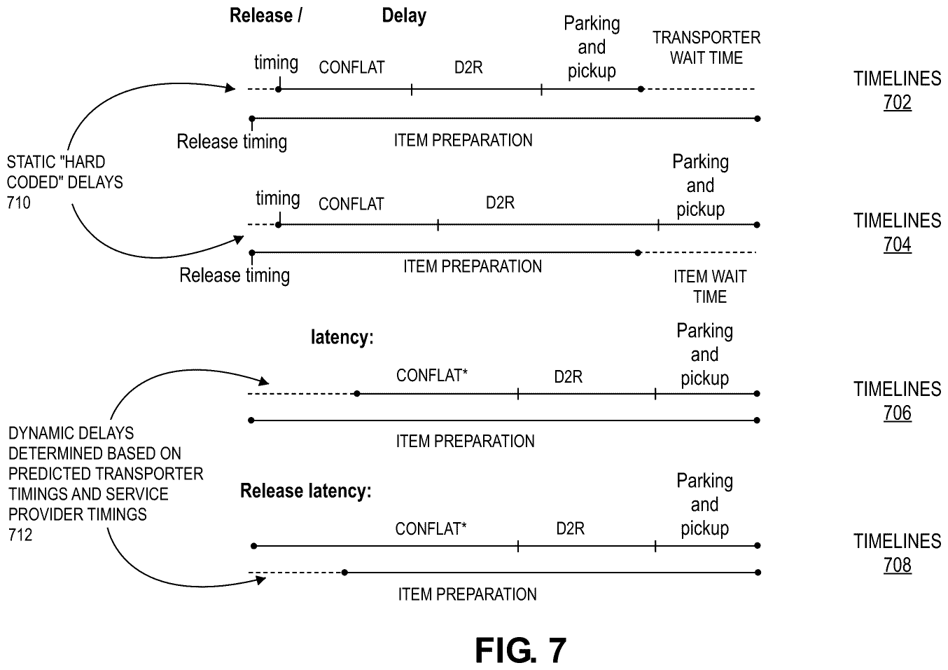

FIG. 7 illustrates some advantages of embodiments of the present disclosure by comparing four sets of timelines 702-708. Timelines 702 and 704 correspond to two scenarios in which methods according to embodiments are not being used. In each case, during an item fulfillment event (e.g., a customer placing an order for a meal from a restaurant), the item fulfillment request is “released” to a service provider, prior to being accepted by a transporter, e.g., a restaurant is informed of an order (via, e.g., a service provider message) before a transporter is informed (via, e.g., a transporter message). In each case, a static “hard-coded” delay 710 is used to attempt to minimize transporter wait times and item wait times.

However, in timeline 702, the CONFLAT time (the amount of time from when an order is placed by an end user to the time that an item fulfillment is accepted by a transporter) and the D2R time (the time it takes the transporter to arrive at the service provider) are relatively low, and item preparation time is relatively high. As a result, the transporter arrives at the service provider before the service provider has completed item preparation, and as a result, the transporter has to wait for the item to be completed.

By contrast, in timeline 704, the CONFLAT time and D2R time are relatively high and the item preparation time is relatively low. As a result, the transporter arrives at the service provider after the service provider has completed item preparation, as such, there is an item wait time. As such, timelines 702-704 illustrate some of the performance issues associated with static delays 710, as the actual variance with item preparation times and transporter arrival times may not be well represented by hardcoded delays (or hardcoded geofences used to implement those delays).

Timelines 706 and 708 illustrate effects of implementing some methods according to embodiments. In each case, a server computer can determine an estimate of the item preparation time, and an estimation of the total transporter time, which can comprise a sum based on an estimation of the CONFLAT time, the D2R time, the parking and pickup time, and a buffer time. The server computer can determine some or all of these estimates using a machine learning model, e.g., a machine learning model trained using data relating to historical item fulfillment requests or features relating to those historical item fulfillment requests.

Based on these estimates, the server computer can dynamically determine time delays 712 between when the item fulfillment is released to the service provider and when the item fulfillment is released to transporters. In timelines 706, the server computer can predict that the total transporter time is lower than the item preparation time, and therefore release the item fulfillment to a service provider before releasing it to a transporter. In timeline 708, the server computer can predict that the total transporter time is greater than the item preparation time, and therefore release the item fulfillment to the transporter prior before releasing it to the service provider. In some embodiments, the server computer can define a geofence based on the difference between an item preparation time estimate and the total transporter time estimate. The server computer can send a message to a service provider computer informing the service provider of the item fulfillment when the transporter crosses the geofence.

As a result, item wait times and transporter wait times are minimized in timelines 706 and 708, resulting in an improved experience for transporters, service providers, and end users. Experiments have shown that, on average, methods according to embodiments can reduce total item fulfillment times by between roughly 2 and 10 seconds globally, e.g., even when considering item fulfillments that are not performed using embodiments of the present disclosure (due to both averaging and network effects).

### A. Experiments

Experiments were conducted that demonstrate performance improvements achieved by using methods according to embodiments. These experiments compared the performance of AOR item fulfillment systems using hardcoded geofences to item fulfillment systems using methods according to embodiments. Before performing these experiments, it was observed that some service providers (particularly quick service restaurants) often had difficultly completing item preparation within 200 to 1000 meter geofences used to trigger item preparation. As such, it was hypothesized that for some AOR item fulfillments, it could be more effective to release orders to service providers before transporters, or alternatively to dynamically set geofence distances.

Some experiments explored other aspects of transporter and item preparation times. It was determined that higher item subtotals lead to a higher likelihood of items not being ready when transporters arrived at service providers. While experimental results varied in different experiments, generally the experiment demonstrated that methods according to embodiments lead to improvements in metrics such as “Distinct Active Time” (DAT), generally corresponding to the average amount of time it takes to complete an item fulfillment from acceptance by a transporter to drop-off at an end user. One experiment, for example, showed a −2.3 second reduction in DAT. For a large number of transporters over a course of a year, this can amount to hundreds of thousands of hours saved in item fulfillments. Further, it was found that in experimental groups, transporters reported that items were not ready at a lower rate (−3.1%) in general, and at an even lower rate for “high wait” service providers (−4.2%). In “high subtotal experiments” (e.g., those corresponding to item fulfillment orders with item values greater than $35), a −1.4 second improvement in DAT was observed, without degrading any other tracked quality metrics.

Experiments were conducted using randomized trials and “switchback” experiment analysis. Broadly, in switchback experiments, experiments alternate between a treatment and a control over time, e.g., between 1:00 P.M. and 2:00 P.M. a treatment is applied and between 2:00 P.M. and 3:00 P.M. no treatment is applied (the control is “applied”). By alternating between treatments and controls, e.g., every 30 minutes, every hour, etc., it is possible to limit the impact of network effects and other uncontrolled variables on the results of the experiments. Switchback experimentation often achieves better performance than conventional A/B experimentation.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer or other suitable display for providing any of the results mentioned herein to a user.

Any of the methods described herein may be totally or partially performed with a computer system including one or more processors, which can be configured to perform the steps. Thus, embodiments can involve computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, and of the steps of any of the methods can be performed with modules, circuits, or other means for performing these steps.

The specific details of particular embodiments may be combined in any suitable manner without departing from the spirit and scope of embodiments of the invention. However, other embodiments of the invention may relate to each individual aspect, or specific combinations of these individual aspects. The above description of exemplary embodiments of the invention has been presented for the purpose of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary. The use of “or” is intended to mean an “inclusive or,” and not an “exclusive or” unless specifically indicated to the contrary.

All patents, patent applications, publications and description mentioned herein are incorporated by reference in their entirety for all purposes. None is admitted to be prior art.

What is claimed is:

1. A method comprising:
receiving, by a server computer, a fulfillment request message associated with an order to deliver an item to an end user by a transporter;
determining, by the server computer, a transporter time estimate, wherein the transporter time estimate is based on a sum based on an estimated confirmation time, an estimated time for the transporter to arrive at a service provider, and an estimated parking and pickup time associated with the order; and
if a preparation time estimate for preparing the item is less than or equal to the transporter time estimate, then adjusting, by the server computer a location and/or 9 size of a geofence that will trigger sending a second message to the service provider to begin preparing the item when the transporter crosses the geofence.

2. The method of claim 1, wherein if the preparation time estimate for preparing the item is greater than the transporter time estimate, then sending a first message to the service provider to begin preparing the item before the transporter crosses the geofence.

3. The method of claim 2, further comprising:
if the preparation time estimate for preparing the item is less than or equal to the transporter time estimate, then, transmitting, by the server computer, a transporter message to a transporter user device, wherein the transporter message informing the transporter to retrieve the item from the service provider; and
if the preparation time estimate for preparing the item is greater than the transporter time estimate, then after a time delay, transmitting, by the server computer, the transporter message to the transporter user device.

4. The method of claim 1, wherein the transporter time estimate further comprises a buffer time.

5. The method of claim 1, wherein the preparation time estimate is based at least upon a subtotal of the order.

6. The method of claim 1, further comprising:
determining, by the server computer, one or more transporter user devices;
providing, by the server computer, the fulfillment request message to the one or more transporter user devices, wherein the one or more transporter user devices determine whether or not to request to accept the fulfillment request message;
receiving, by the server computer, an acceptance message from a transporter user device of the one or more transporter user devices;
generating, by the server computer, an update message indicating a status of the order; and
providing, by the server computer, the update message to an end user device.

7. The method of claim 6, wherein the item is a food item in the order, the order including other food items.

8. The method of claim 6, wherein the item is delivered along with other items provided by the service provider.

9. The method of claim 1, wherein the server computer determines the preparation time estimate using a first machine learning model and wherein the server computer determines the transporter time estimate using a second machine learning model.

10. The method of claim 9, wherein the first machine learning model comprises a light gradient boosting machine (LGBM).

11. The method of claim 9, wherein the geofence is determined based on a product of (1) a difference between the preparation time estimate and the transporter time estimate and (2) an estimated transporter velocity.

12. The method of claim 1, further comprising:
if the preparation time estimate for preparing the item is less than or equal to the transporter time estimate, then, transmitting, by the server computer, a transporter message to a transporter user device, wherein the transporter message informing the transporter to retrieve the item from the service provider; and
if the preparation time estimate for preparing the item is greater than the transporter time estimate, then after a time delay, transmitting, by the server computer, the transporter message to the transporter user device, and
wherein the time delay is based on a geolocation of the transporter, the transporter time estimate, and the preparation time estimate.

13. The method of claim 1,
wherein the geofence is to be applied to the order, and wherein if the preparation time estimate for preparing the item is greater than the transporter time estimate, then sending a first message to the service provider to begin preparing the item before the transporter crosses the geofence, and
wherein if the preparation time estimate for preparing the item is greater than or equal to the transporter time estimate, then sending the first message to the service provider to begin preparing the item immediately.

14. The method of claim 1, wherein the transporter is an autonomous vehicle.

15. A computer system comprising:
a processor; and
a non-transitory computer readable medium coupled to the processor, the non-transitory computer readable medium coupled to the processor, the non-transitory computer readable medium comprising code, executable by the processor for performing a method comprising:
receiving a fulfillment request message associated with an order to deliver an item to an end user by a transporter;
determining a transporter time estimate, wherein the transporter time estimate is based on a sum based on an estimated confirmation time, an estimated time for the transporter to arrive at a service provider, and an estimated parking and pickup time associated with the order; and
if a preparation time estimate for preparing the item is less than or equal to the transporter time estimate, then adjusting a location and/or size of a geofence that will trigger sending a second message to the service provider to begin preparing the item when the transporter crosses the geofence.

16. The computer system of claim 15, wherein if the preparation time estimate for preparing the item is greater than the sum, then sending a first message to the service provider to begin preparing the item before the transporter crosses the geofence.

17. The computer system of claim 15, wherein the preparation time estimate is based at least upon a number of items in the order.

18. The computer system of claim 15, the method further comprising:
determining one or more transporter user devices;
providing the fulfillment request message to the one or more transporter user devices, wherein the one or more transporter user devices determine whether or not to request to accept the fulfillment request message;
receiving an acceptance message from a transporter user device of the one or more transporter user devices;
generating an update message indicating a status of the order; and
providing the update message to an end user device.

19. The computer system of claim 15, wherein the preparation time estimate is determined using a first machine learning model and wherein the sum is determined using a second machine learning model.

20. The computer system of claim 19, wherein the first machine learning model comprises a light gradient boosting machine (LGBM).
